(19) United States
(12) Patent Application Publication
(10) Pub. No.: US 2007/0153731 A1
(43) Pub. Date: Jul. 5, 2007

(54) VARYING SIZE COEFFICIENTS IN A WIRELESS LOCAL AREA NETWORK RETURN CHANNEL

(76) Inventor: Nadav Fine, Kokhav Yair (IL)

Correspondence Address: FLEIT KAIN GIBBONS GUTMAN BONGINI & BIANCO, 21355 EAST DIXIE HIGHWAY, SUITE 115, MIAMI, FL, 33180, US

(21) Appl. No.: 11/463,329

(22) Filed: Aug. 9, 2006

Related U.S. Application Data
(60) Provisional application No. 60/756,228, filed on Jan. 5, 2006.

(51) Int. Cl. H04Q 7/00

(52) U.S. Cl. 370/329

(57) ABSTRACT

Sending channel related parameters known as channel state information (CSI) over a WLAN return channel. The size of these coefficients is not fixed. Rather, the coefficients are quantized in a certain resolution, which is determined adaptively according to a measure of the channel quality. This allows minimizing the component of the bandwidth of the wireless connection that is not used for payload transfer.

### CROSS-REFERENCE TO RELATED APPLICATIONS

This application claims the benefit of Provisional App. No. 60/756,228, filed Jan. 5, 2006.

### FIELD OF THE INVENTION

The invention relates to wireless communication, more particularly packet communication techniques, such as wireless local area network (WLANs), and more particularly to wireless network communication techniques involving multiple antenna systems and beamforming.

### BACKGROUND OF THE INVENTION

Highly functional computers may be interconnected with one another in what is termed a local area network (LAN) to enable users of individual computers which are connected to the network to send data and files to one another. Traditional hardwired LANs are being superceded by wireless LANs (WLANs).

Achieving higher throughput in wireless local area networks (WLANs) is an ongoing goal of the wireless infrastructure industry. Although data transfer rate in WLANs has improved immensely during the last years, they are still lagging after the data transfer rates offered by lined (wired) networks. One of the challenges of emerging higher throughput standards is minimizing the part of the bandwidth that deals with the communication protocol rather than purely transferring data.

802.11

The Institute of Electrical and Electronic Engineers (IEEE) standard IEEE 802.11 or Wi-Fi denotes a set of Wireless LAN standards developed by working group 11 of IEEE 802. The term is also used to refer to the original 802.11, which is now sometimes called “802.11 legacy”. The 802.11 family currently includes six over-the-air modulation techniques that all use the same protocol, the most popular (and prolific) techniques are those defined by the a, b, and g amendments to the original standard; security was originally included, and was later enhanced via the 802.11i amendment. Other standards in the family (c-f, h-j, n) are service enhancement and extensions, or corrections to previous specifications. 802.11b was the first widely accepted wireless networking standard, followed (somewhat counterintuitively) by 802.11a and 802.11g. 802.11b and 802.11g standards use the unlicensed 2.4 GHz band. The 802.11a standard uses the 5 GHz band. Operating in an unregulated frequency band, 802.11b and 802.11g equipment can incur interference from microwave ovens, cordless phones, and other appliances using the same 2.4 GHz band.

IEEE 802.11, provides protocols for a physical (PHY) layer and a Medium Access Control (MAC) layer. Generally, the PHY layer provides protocol for the hardware of WLANs termed stations or nodes. A station may be mobile station, wireless enabled laptop or desktop personal computer, and the like. The PHY layer concerns transmission of data between those stations, and there are currently four different types of PHY layers: direct sequence spread spectrum (DSSS), frequency-hopping spread spectrum (FHSS), infrared (IR) pulse modulation, and orthogonal frequency-division multiplexing (OFDM). Generally, the MAC Layer manages and maintains communications between 802.11 stations (radio network cards and access points) by coordinating access to a shared radio channel and utilizing protocols that enhance communications over a wireless medium.

In January 2004 IEEE announced that it had formed a new 802.11 Task Group (TGn) to develop a new amendment to the 802.11 standard for local-area wireless networks. The real data throughput will be at least 100 Mbit/s (which may require an even higher raw data rate at the PHY level), and so up to 4-5 times faster than 802.11a or 802.11g, and perhaps 20 times faster than 802.11b. As projected, 802.11n will also offer a better operating distance than current networks. The standardization process is expected to be completed by the end of 2006. 802.11n builds upon previous 802.11 standards by adding MIMO (multiple-input multiple-output). The additional transmitter and receiver antennas allow for increased data throughput through spatial multiplexing and increased range by exploiting spatial diversity.

Data protocols for WLANs are generally organized into layers or levels of the communication system, each layer facilitating interoperability between various entities within the network. The present invention deals with what is known as the physical layer.

The physical layer is the layer is the layer that conveys the bit stream—electrical impulse, light or radio signal—through the network at the electrical and mechanical level. It provides the hardware means of sending and receiving data on a carrier, including defining cables, cards and physical aspects. Fast Ethernet, RS232, and ATM are protocols with physical layer components. The physical layer (PHY) is simply wiring, fiber, network cards, and anything else that is used to make two network devices communicate.

Existing wireless local area networks (WLAN) support data rates from 11 MBit/s (IEEE 802.11b) to 54 MBit/s (IEEE 802.11a/g). Recent research results have demonstrated that multiple-input multiple-output (MIMO) communication systems are able to substantially increase the data rate (bit/sec) and/or to improve the transmission quality (bit error rate) in a wireless point-to-point link without additional expenditure in power or bandwidth.

FIG. 1A is a diagram of a conventional SISO wireless system of the prior art. Conventional single-input single-output (SISO) systems were favored for simplicity and low cost, but have some shortcomings.
Outage occurs if antennas fall into null
Energy is wasted by sending in all directions
Can cause additional interference to others
Sensitive to interference from all directions
Output power limited by single power amplifier

FIG. 1B is a diagram of a conventional MIMO wireless system of the prior art. Multiple Input Multiple Output (MIMO) systems with multiple parallel radios improve the following:
Outages reduced by using information from multiple antennas
Transmit power can be increased via multiple power amplifiers
Higher throughputs possible
Transmit and receive interference limited by some techniques

There are two basic types of MIMO technology: Beamforming MIMO and Spatial-multiplexing MIMO. Beamforming MIMO uses standards-compatible techniques to improve the range of existing data rates using transmit and receive beamforming, and also reduces transmit interference and improves receive interference tolerance. Spatial-multiplexing MIMO allows even higher data rates by transmitting parallel data streams in the same frequency spectrum. Since spatial multiplexing MIMO fundamentally changes the on-air format of signals, it requires the new standard (802.11n) for standards-based operation.

Besides spatial multiplexing which may be used to increases rate, a MIMO system can use a space-time code (STC) to gain diversity: multiple channels between a plurality of antennas lower the probability for outage described above. The fundamental difference between STC and beamforming, is that for beamforming, channel knowledge is required.

FIG. 1C is a diagram illustrating receive beamforming, according to the prior art. Receive beamforming uses two (or more) antennae (and corresponding two or more radios) at a receiver for combining and boosts reception of standard 802.11 signals. The present invention deals with transmit beamforming, described in the next paragraph.

FIG. 1D is a diagram illustrating transmit beamforming, according to the prior art. Phased array transmit beamforming uses two (or more) antennae (and corresponding two or more radios) at a transmitter to focus energy to (essentially, in the direction of) each receiver.

FIG. 1E is a diagram illustrating the spatial multiplexing MIMO concept, according to the prior art. Spatial-multiplexing MIMO requires two (or more) antennae at each of the receiver and transmitter (and corresponding two or more radios), and forms multiple independent links (on same channel) between transmitter and receiver to communicate at higher total data rates. At the transmitter (Tx), an incoming bitstream is split and provided to the two or more radios driving the two or more antennae. At the receiver (Rx), the signals from the two or more radios are merged to recreate the bitstream.

FIG. 1F is a diagram illustrating the spatial multiplexing MIMO reality, according to the prior art. With MIMO, there are direct links between antennae, such as a link from transmit antenna 1 (Tx1) to receive antenna 1 (Rx1) and a link from transmit antenna 2 (Tx2) to receive antenna 2 (Rx2), but there are also cross-paths formed between the antennas, such as from Tx1 to Rx2, and from Tx2 to Rx1. The resulting correlations must be decoupled by digital signal processing (DSP) algorithms.

FIG. 1G is a diagram illustrating the MIMO hardware requirements for a MIMO transmitter (employing parallelism and data rate scaling), according to the prior art.

FIG. 1H is a diagram illustrating the MIMO hardware requirements for a MIMO receiver (employing parallelism and data rate scaling), according to the prior art.

FIG. 1I is a diagram illustrating a WLAN station, according to the prior art.

It is anticipated that multimedia streaming over the Internet will have a significant share in tomorrow's communications. Also, end users increasingly seek mobility, thus paving the way for extensive deployment of wireless technologies like IEEE 802.11. The joint effect is that support is needed for multimedia streaming over connections that include both fixed and wireless links.

Streaming multimedia content in real-time over a wireless link is a challenging task because of the rapid fluctuations in link conditions that can occur due to movement, interference, and so on. The popular IEEE 802.11 standard includes low-level tuning parameters like the transmission rate. Standard device drivers for today's wireless products are based on gathering statistics, and consequently, adapt rather slowly to changes in conditions.

Streaming over a wireless link (the last hop) is a bottleneck for two reasons: First, communication over a wireless channel is simply not able to achieve the same quality (throughput, error rate, etc.) as its wired counterpart, which reduces the quality of the multimedia content that can be delivered. Second, in a mobile environment, the channel conditions can change rapidly due to changing distance between the stations (user mobility), Rayleigh fading, interference and so on. Since multimedia streaming applications must deliver their content in real time, they are very sensitive to jitter in packet delivery caused by retransmissions in the underlying transport protocols. Consequently, when using streaming applications, users experience reduced range compared to the case when less demanding applications like file downloading and web browsing are used.

In order to decide, for example, which rate and/or which beamforming coefficients are optimal at each specific moment, a control algorithm needs information about the current link conditions, or so-called channel state information (CSI). Generally, CSI is crucial for transmit beam forming, which can improve link performance.

### RELATED PATENTS AND PUBLICATIONS

WO2005/029804 (“Intel”), incorporated in its entirety by reference herein, discloses channel estimation feedback in an orthogonal frequency division multiplexing (OFDM) multiplexing system. A channel state information packet is encoded by a receiver side device and is fed back to the transmitter side device. The transmitter side device decodes the channel state information packet to extract an estimate of the channel response function. See also US 20050058095.

As noted in Intel, in a wireless local area network (WLAN) communication system such as an orthogonal frequency division multiplexing (OFDM) system, the data rate and quality at which a transmitter is able to transmit data to a receiver may be limited by the quality of the channel. However, a typical transmitter does not have the benefit of channel information when making such adjustments to the data rate and modulation scheme. Furthermore, without knowledge of the channel information, the transmitter may spend more energy than is necessary for exchanging data and other information between the transmitter and the receiver, thereby resulting in wasted power.

Intel shows, at FIG. 2 thereof, a channel estimation feedback encoder that may be implemented in a receiver of either transceiver of mobile unit, or may be implemented in a receiver of transceiver of access point. When a first device transmits to a second device, an estimate of the channel, or channel state information (CSI) packet, may be fed back from the second device to the first device, for example to adapt transmission modulation according to the characteristics of the channel. In one particular embodiment, channel state information may consist of a channel transfer function estimate in frequency domain or channel response function estimate in time domain. In an alternative embodiment, a remote user may process channel function estimates itself, for example using bit and power loading block, and then transmit power allocation and modulation type instructions as the ready to use channel state information back to the original transmitting device.

As noted in Intel, the channel estimation feedback encoder may generate a channel estimate or Channel State Information (CSI) packet, such as represented by a bitstream, to be fed back from mobile unit to access point after a transmission from access point to mobile unit has occurred. For example, the channel estimate information may be included as a part of the acknowledgement frame sent by mobile unit to access point after receiving a packet of data transmitted from access point to mobile unit. Channel estimation feedback encoder may execute an algorithm to encode the channel estimation information to be fed back to access point. The input to channel estimation feedback encoder may be the actual channel characteristic in the frequency domain, for example channel transfer function coefficients from a standard channel estimator of the receiver in transceiver of mobile unit in accordance with the IEEE 802.11a standard. The channel characteristic may comprise M complex number, for example M=52 in accordance with the IEEE 802.11a standard.

As noted in Intel, the output encoder may be the CSI packed into a bit stream. The algorithm executed by encoder may include one or more optional features, for example to allow a varying level of complexity and information compression ratio. In one or more embodiments of the invention, one such option may be to ensure the best quality, or a near best quality, of the channel estimation or alternatively to minimize the time for encoding feedback packet, or yet alternative to minimize the value of the CSI. In accordance with one embodiment of the present invention, the algorithm executed by channel estimation feedback encoder 200 may permit two kinds of the channel estimation packets: an INTRA (I) packet or a PREDICTIVE (P) packet. The INTRA packet may contain all the data necessary to reconstruct the channel characteristic in the frequency domain. The INRTA packet may be utilized as a first feedback packet or after a long connection interruption. The PREDICTIVE packet may contain the differences between a current packet and a channel estimation (CE). Such PREDICTIVE packets may be utilized for successive improvement of the channel estimation accuracy or to indicate that the channel characteristic may have changed.

As noted in Intel, coding of the channel estimation (CE) packet may consist of four stages of encoder: Inverse Fast Fourier Transform and Data Cut-Off block, Predictor Calculation block (for P Packets), Data Quantization block, and Bitstream Formation block. Inverse FFT and Cut-Off block may perform an Inverse Fast Fourier Transform (IFFT) on an input array of M complex numbers received at input to obtain a representation of the signal in the time-domain, the channel response function, as an array of complex numbers in a magnitude and phase representation. The signal may be cut-off at N complex numbers having time delays that are less than a channel delay spread, where for example N may be less than M, and the channel delay spread may be less than 800 ns. Thus, the output of Inverse FFT and Cut-Off block may represent an actual channel response function represented by N complex numbers. In an alternative embodiment, Inverse FFT and Cut-Off block may be optionally omitted wherein the channel state information may be directly encoded in the frequency domain. In other embodiment of the invention, another some special processing algorithm may be utilized instead of an Inverse FFT at Inverse FFT and Cut-Off block to calculate a transmission modulation request.

As noted in Intel, a quantization block may quantize the N complex numbers of the channel response function or its residuals. In one embodiment, quantization block may perform a linear quantization in which samples in the channel response function array are divided by a fixed quantizer value. Different quantizer values may be utilized for phase and magnitude components. In one particular embodiment quantizer values may be a power of 2. Such a linear quantization may be utilized for PREDICTIVE (P) packets. In another embodiment, quantization block may perform a channel attenuation estimation. In such an embodiment, quantization block may estimate a time delay attenuation function of the magnitude of a given ray where the magnitude is e^{-at} where a is attenuation. In one embodiment, aln2 may be estimated. Such a channel attenuation estimation performed by the quantization block may be utilized for INTRA(I) packets. Quantizer values may be chosen on the basis of some a priori, or advanced, knowledge of the channel response function distribution or the time history of the channel response function by utilizing an iterative procedure to ensure the coded data may fit into a redefined packet size and with a minimal loss of the information. The output of the quantization block may be quantized values of the channel response function, which may be fed back to a predictor calculation block via a de-quantization block.

As noted in Intel, with reference to FIG. 3 therein, the output of channel estimation update block may be an estimation of the channel response function for the current channel. Forward FFT block may perform a forward Fast Fourier Transform (FFT) on the estimation of the channel response function to provide a channel estimation in the frequency domain at output. The original transmitter may then utilize the channel estimation for subsequent transmissions to the original receiver, for example to adjust the modulation scheme to the current channel conditions, although the scope of the invention is not limited in this respect.

US2005/0147075 (“Terry”), incorporated in its entirety by reference herein, discloses system topologies for optimum capacity transmission over wireless local area networks. A method provides optimum topology for a multi-antenna system dedicated to higher throughput/capacity by bundling the Point Coordination Function (PCF) operation in infrastructure mode of the current and/or enhanced IEEE MAC with PHY specifications that employ some form of coherent weighting based on CSI at the transmitter in conjunction with the corresponding optimum receiver detection based on CSI. Specifically, CSI is measured from a control message, so data messages and control messages are separated. In the contention period of IEEE 802.11, the RTS/CTS exchange is used for CSI and the data message is sent following the CTS message. In the contention free period, a poll by the PC is separated from a data frame, which gives the polled station the first opportunity to send a data message. This change in topology results in various changes to the frame exchange format in the CFP for various scenarios of data and control messages to be exchanged.

Terry relates broadly to Wireless Local Area Networks (WLANs) and specifically to a topology for multi-channel wireless time division duplex (TDD) systems so that channel state information (CSI) may be acquired and used to optimize data throughput.

As noted in Terry, it is well-known that optimum capacity is achieved when Channel State Information (CSI) is known and used at both the transmitter and receiver, and that MIMO systems (multiple input/receive antennas and/or multiple output/transmit antennas) provide a substantial increase in capacity as compared to more traditional systems employing a single antenna on all transceivers. For example, knowing CST enables a transmitter to parse data among different channels in a manner that takes advantage of the entire channel capacity on each channel, rather than allowing the time-sensitive bandwidth to be not fully used.

Terry discloses a topology for a multi-antenna system dedicated to higher throughput/capacity by bundling the Point Coordination Function (PCF) operation in infrastructure mode of the current and/or enhanced IEEE MAC with PHY specifications that employ some form of coherent weighting based on CSI at the transmitter in conjunction with the corresponding optimum receiver detection based on CSI.

In an embodiment, Terry discloses a method of communicating over multiple sub-channels of a WLAN. The method includes sending a control message that is not combined with a data message from a first network entity to a second network entity. The control message may be, for example, a CTS message during the CP (contention period) or a poll during the CFP (contention free period), but in any case the control message is to facilitate sequencing of wireless transmissions among at least two entities in a wireless network. In the inventive method, the control message is received at the second network entity, which uses it to obtain channel state information CSI. The CSI is used to determine the capacities of at least a first and second sub-channel of the wireless network, and to determine which has the greater capacity.

In an embodiment, Terry discloses a method of communicating data over a wireless network according to an IEEE 802.11 standard which includes separating by at least one Short InterFrame Space (SIFS) a poll and a data message sent by a point controller PC while in a contention free period (CFP). This allows data messages sent from the PC to be transmitted with the benefit of knowing CSI. CSI is also obtained during the contention period CP during a Request-to-Send/Clear-to-Send RTS/CTS exchange. In that instance, CSI is used to determine relative capacities of at least a first and second sub-channel to parse a data message from a station sending the RTS to a station sending the CTS. Specifically, a data message from the RTS-sending station is parsed into at least a first data message segment defining a first size and a second data message segment defining a smaller second size. The relative segment sizes are based on relative capacities of a first and second sub-channel as determined by the measured CSI.

US2005053170 (“Catreux”), incorporated in its entirety by reference herein, discloses frequency selective transmit signal weighting for multiple antenna communication systems. A system and method for generating transmit weighting values for signal weighting that may be used in various transmitter and receiver structures is disclosed. The weighting values are determined as a function of frequency based upon a state of a communication channel and the transmission mode of the signal. In variations, weighting of the weighted signal that is transmitted through each of a plurality of antennas is carried out with one of a corresponding plurality of transmit antenna spatial weights. In these variations, a search may be conducted over various combinations of transmit weighting values and transmit antenna spatial weights in order to find a weight combination that optimizes a performance measure such as the output signal-to-noise ratio, the output bit error rate or the output packet error rate.

FIG. 4 of Catreux shows a block diagram of a single carrier system using one transmit antenna and a receiver with two receive antennas. The transmitter includes an encoder block, a channel state information (CSI) and mode portion, a weight calculation portion and a signal weighting portion. The receiver includes a maximum likelihood sequence estimation (MLSE) equalizer 418.

As noted in Catreux, channel state information (CSI) is acquired, and in some embodiments, operations to acquire CSI are carried out at the receiver, and the relevant information is fed back over the air, via a control message, to the transmitter to the CSI and mode acquisition portion of the transmitter. In these embodiments, a training sequence composed of known symbols is sent from the transmitter to the receiver. At the receiver the channel is estimated based on the received signal and the known sequence of symbols.

There exist many channel estimation techniques based on training sequences, e.g., see J.-J. van de Beek et al., “On Channel Estimation in OFDM Systems,” IEEE 45th Vehicular Technology Conference, vol. 2, 25-28 Jul. 1995, pp. 815-819, which is incorporated by reference herein.

As noted in Catreux, in some embodiments, once the channel is known, an algorithm is employed to decide which of the possible mode candidates is best suited to the current CSI. The algorithm is usually referred to as link adaptation, which ensures that the most efficient mode is always used, over varying channel conditions, given a mode selection criterion (maximum data rate, minimum transmit power). At this point, both channel state and mode information may be fed back to the transmitter, and the weight calculation portion uses this information to compute the transmit signal weight values.

Additional details on link adaptation for frequency-selective MIMO systems may be found in “Adaptive Modulation and MIMO Coding for Broadband Wireless Data Networks,” by S. Catreux et al., IEEE Communications Magazine, vol. 40, No. 6, June 2002, pp. 108-115, which is incorporated by reference herein.

As noted in Catreux, in variations of these embodiments, transmit signal weight values are alternatively calculated at the receiver and the resulting weights are fed back to the transmitter via a control message over the air. Note that this feedback assumes that the channel varies slowly enough that there is sufficient correlation between the CSI used to compute the weights at the receiver and the CSI the weights are applied to at the transmitter. In other embodiments, all operations to establish CST and mode acquisition are carried out at the transmitter. In certain systems (e.g., Time Division Duplex (TDD) systems in noise-limited environment) the uplink channel is the same as the downlink channel. Therefore, the transmitter may estimate the channel, compute the mode and transmit signal weight values and use those estimated parameters for transmission over the downlink channel. In these other embodiments, the transmitter receives a training sequence from the uplink channel, carries out channel and mode estimation and finally computes the transmit signal weight values. This avoids the need for feedback. After the channel state becomes available, the default weights are replaced by more optimal frequency weights that are computed (e.g., by the weight calculation portion) based on the current CSI and current mode. In the multiple carrier (OFDM) embodiments described with reference to FIGS. 5A and 5B, each tone is scaled by a transmit signal weight based on the current CSI and current mode.

US2005135403 (“Ketchum”), incorporated in its entirety by reference herein, discloses method, apparatus and system for medium access control. Embodiments addressing MAC processing for efficient use of high throughput systems are disclosed. In one aspect an apparatus comprises a first layer for receiving one or more packets from one or more data flows and for generating one or more first layer Protocol Data Units (PDUs) from the one or more packets. In another aspect, a second layer is deployed for generating one or more MAC frames based on the one or more MAC layer PDUs. In another aspect, a MAC frame is deployed for transmitting one or more MAC layer PDUs. The MAC frame may comprise a control channel for transmitting one or more allocations. The MAC frame may comprise one or more traffic segments in accordance with allocations.

FIG. 1 of Ketchum shows a system comprising an Access Point (AP) connected to one or more User Terminals (UTs). The AP and the UTs communicate via Wireless Local Area Network (WLAN). In the example embodiment, WLAN is a high speed MIMO OFDM system. However, WLAN may be any wireless LAN. Access point communicates with any number of external devices or processes via network. Network may be the Internet, an intranet, or any other wired, wireless, or optical network. Connection carries the physical layer signals from the network to the access point. Devices or processes may be connected to network or as UTs (or via connections therewith) on WLAN. Examples of devices that may be connected to either network or WLAN include phones, Personal Digital Assistants (PDAs), computers of various types (laptops, personal computers, workstations, terminals of any type), video devices such as cameras, camcorders, webcams, and virtually any other type of data device.

As noted in Kethcum, the wireless LAN transceiver may be any type of transceiver. In an example embodiment, wireless LAN transceiver is an OFDM transceiver, which may be operated with a MIMO or MISO interface. OFDM, MIMO, and MISO are known to those of skill in the art. Various example OFDM, MIMO and MISO transceivers are detailed in US 2005/0047515, incorporated in its entirety by reference herein.

WO2005062515 (“Sandhu”), incorporated in its entirety by reference herein, discloses transmission of data with feedback to the transmitter in a wireless local area network or the like. A transmitter may adaptively select between a post-data channel feedback system and a pre-data channel feedback system based at least in part on packet length and channel conditions. See also US2005/0030897.

As noted in Sandhu, a mobile unit may communicate with access point via wireless communication link, where access point may include at least one antenna. In an alternative embodiment, access point and optionally mobile unit may include two or more antennas, for example to provide a spatial division multiple access (SDMA) system or a multiple input, multiple output (MIMO) system.

Reference is made to the following articles, incorporated in their entirety by reference herein.
“On Limits of Wireless Communications in a Fading Environment When Using Multiple Antennas”, by G. J. Foschini et al, Wireless Personal Communications, Kluwer Academic Publishers, vol. 6, No. 3, pages 311-335, March 1998.
“Simplified processing for high spectral efficiency wireless communication employing multi-element arrays”, by G. J. Foschini, et al, IEEE Journal on Selected Areas in Communications, Volume: 17 Issue: 11, November 1999, pages 1841-1852.
“Automatic IEEE 802.11 Rate Control for Streaming Applications”, by Haratcherev, et al. Faculty of Electrical Engineering, Mathematics and Computer Science, Delft University of Technology, Mekelweg 4, 2628 CD Delft, The Netherlands. “802.11 Wireless Networks, The Definitive Guide”, Matthew S. Gast, Chapter 15, “A Peek Ahead at 802.11n: MIMO-OFDM”. pp 311-342.

### GLOSSARY, DEFINITIONS, BACKGROUND

Unless otherwise noted, or as may be evident from the context of their usage, any terms, abbreviations, acronyms or scientific symbols and notations used herein are to be given their ordinary meaning in the technical discipline to which the disclosure most nearly pertains. The following terms, abbreviations and acronyms may be used throughout the descriptions presented herein and should generally be given the following meaning unless contradicted or elaborated upon by other descriptions set forth herein. Some of the terms set forth below may be registered trademarks®.
Access Point Access points are the devices which provide a connection between one or more wireless devices and a wired network.
Adhoc network A type of network without any centralized control it is also called as basic server set or peer-to-peer network. In an adhoc network, stations communicate directly with each other through the SS ID.
Asynchronous (i.e. Not Synchronous) A form of concurrent input and output communication transmission with no timing relationship between the two signals.
Bandwidth It is a measure of the significant spectral content.
Base station A transmitting/receiving station fixed at a location serving one or more subscriber stations.
Beacon To keep the network synchronized access points or stations broadcast a type of packet called as Beacon.
beamforming Using two or more antennae and controlling their outputs to control the RF signal being transmitted. (also “beam forming”, also “beam-forming”)
carrier A high frequency signal used to modulate the message signal. Various parameters of the carrier can be modified such as phase, amplitude, frequency.
CSI Short for channel state information.
CSMA Carrier Sense Multiple Access—A listen before talk scheme used to mediate the access to a transmission resource. All stations are allowed to access the resource but are required to make sure the resource is free before transmitting.
CTS short for clear to send. CTS is a signal from the receiving station to the transmitting station granting permission to transmit data. In a wireless network a station responds to a RTS with a CTS frame, providing clearance for the requesting station to send data.
CTS Short for clear to send. One of the nine wires in a serial port used in modern communications, CTS carries a signal from the modem to the computer saying, “I'm ready to start when you are.”
DAC Short for Digital to Analog Converter (D/A converter). An electronic device or a piece of software, often integrated, that converts a digital number or signal into a corresponding analog voltage or current.
Explicit TBF The transmitter sends a sounding packet to the receiver, which measures it and responds with the required transmitter coefficients for optional TBF SNR.
Frame The format of aggregated bits from a medium access control (MAC) sublayer that are transmitted together in time. The Frame usually consists of representation of the data to be transmitted/received, together with other bits which may be used for error detection or control.
Givens rotation The main use of Givens rotations in numerical linear algebra is to introduce zeros in vectors/matrices. This effect can e.g. be employed for computing the QR decomposition of a matrix; one advantage over Householder transformations is that they can easily be parallelised, and another is that for many very sparse matrices they have lower operation count.
Householder transformation A Householder transformation in 3-dimensional space is the reflection of a vector in a plane. In general Euclidean space it is a linear transformation that describes a reflection in a hyperplane (containing the origin). The Householder transformation was introduced in 1958 by Alston Scott Householder. It can be used to obtain a QR decomposition of a matrix.
IEEE Short for “Institute of Electrical and Electronics Engineers”. The IEEE is best known for developing standards for the computer and electronics industry.
IEEE 802.11 The IEEE standard for wireless Local Area Networks (LANs). It uses three different physical layers, 802.11a, 802.11b and 802.11g. The term 802.11x is also used to denote this set of standards, and should not be mistaken for any one of its elements. There is no single 802.11x standard. The term IEEE 802.11 is also used to refer to the original 802.11, which is now sometimes called “802.11 legacy.”
IEEE 802.11n This WiFi standard is designed to operate between 100-600 Mbps. The specification includes improved power management for handheld devices, unlike some of the earlier 802.11 specifications. Beamforming and space-time block coding (STBC), methods of improving the reliability and efficiency, are also included.
IP Short for Internet protocol. The Internet Protocol (IP) is a data-oriented protocol used by source and destination hosts for communicating data across a packet-switched internetwork. Data in an IP internetwork are sent in blocks referred to as packets or datagrams (the terms are basically synonymous in JP). In particular, in IP no setup of “path” is needed before a host tries to send packets to a host it has previously not communicated with.
ISO Short for International Standards Organization. An ISO standard is an international standard published by the ISO. Over 15000 ISO standards have been published so far, each identified by a document number.
LAN Short for Local Area Network. A computer network that spans a relatively small area. Most LANs are confined to a single building or group of buildings. However, one LAN can be connected to other LANs over any distance via telephone lines and radio waves. A system of LANs connected in this way is called a wide-area network (WAN).
Latin A human language. Some Latin terms (abbreviations) may be used herein, as follows:
   cf. Short for the Latin “confer”. As may be used herein, “compare”.
   e.g. Short for the Latin “exempli gratia”. Also “eg” (without periods). As may be used herein, means “for example”.
   etc. Short for the Latin “et cetera”. As may be used herein, means “and so forth”, or “and so on”, or “and other similar things (devices, process, as may be appropriate to the circumstances)”.
   i.e. Short for the Latin “id est”. As may be used herein, “that is”.
   sic meaning “thus” or “just so”. indicates a misspelling or error in a quoted source
lossy compression Lossless and lossy compression are terms that describe whether or not, in the compression of a file, all original data can be recovered when the file is uncompressed. With lossless compression, every single bit of data that was originally in the file remains after the file is uncompressed. All of the information is completely restored. This is generally the technique of choice for text or spreadsheet files, where losing words or financial data could pose a problem. The Graphics Interchange File (GIF) is an image format used on the Web that provides lossless compression. On the other hand, lossy compression reduces a file by permanently eliminating certain information, especially redundant information. When the file is uncompressed, only a part of the original information is still there (although the user may not notice it). Lossy compression is generally used for video and sound, where a certain amount of information loss will not be detected by most users. The JPEG image file, commonly used for photographs and other complex still images on the Web, is an image that has lossy compression. Using JPEG compression, the creator can decide how much loss to introduce and make a trade-off between file size and image quality.
   MAC Short for Medium Access Control. In IEEE 802 networks, the Data Link Control (DLC) layer of the OSI Reference Model is divided into two sublayers: the Logical Link Control (LLC) layer and the Media Access Control (MAC) layer. The MAC layer interfaces directly with the network medium. Consequently, each different type of network medium requires a different MAC layer. The MAC layer is the lower layer in OSI model prior to PHY layer. The primary functions of the MAC layer are to control and access the physical medium, and also to perform fragmentation and de fragmentation of packets. A MAC address is a hardware address that uniquely identifies each node of a network. On networks that do not conform to the IEEE 802 standards but do conform to the OSI Reference Model, the node address is called the Data Link Control (DLC) address.
matrix A matrix (plural matrices) is a rectangular table of numbers or, more generally, of elements of a ring-like algebraic structure. A rectangular matrix has rows and columns. A square matrix is a matrix which has the same number of rows as columns. Matrices are useful to record data that depend on two categories, and to keep track of the coefficients of systems of linear equations and linear transformations.

MIMO Short for Multiple-input multiple-output. MIMO is an abstract mathematical model for some communications systems. In radio communications if multiple antennas are employed, the MIMO model naturally arises. MIMO exploits phenomena such as multipath propagation to increase throughput, or reduce bit error rates, rather than attempting to eliminate effects of multipath. MIMO can also be used in conjunction with OFDM, and it will be part of the IEEE 802.11n High-Throughput standard, which is expected to be finalized in late 2007. MIMO has just been added to the latest draft version of Mobile WiMAX (802.16e). It has been shown that the channel capacity (a theoretical measure of throughput) for a MIMO system is increased as the number of antennas is increased, proportional to the minimum of number of transmit and receive antennas.
MSE Short for Minimum Square Error. MSE is the minimum mean-square error (also known as MMSE) performance measure is a popular metric for optimal signal processing.
Modulation Modulation is the process by which some characteristics of the message signal are varied in accordance with the modulating wave.
Multipath In addition to direct path from transmitter to receiver there exist several indirect paths. The interference caused due to these indirect paths is called multipath.
multiplexing In telecommunications, multiplexing (also muxing or MUXing) is the combining of two or more information channels onto a common transmission medium using hardware called a multiplexer or (MUX). The reverse of this is known as inverse multiplexing, demultiplexing, or demuxing. In electrical communications, the two basic forms of multiplexing are time-division multiplexing (TDM) and frequency-division multiplexing (FDM). Code division multiple access (CDMA) is a form of multiplexing (not a modulation scheme) and a method of multiple access that does not divide up the channel by time (as in TDMA), or frequency (as in FDMA), but instead encodes data with a certain code associated with a channel and uses the constructive interference properties of the signal medium to perform the multiplexing.
OFDM Orthogonal Frequency Division Multiplexing (OFDM) is a modulation technique in which a radio signal is divided into multiple narrow frequency bands to transmit large amounts of data.
OSI Short for Short for Open Systems Interconnection. The OSI Reference Model commonly known as OSI Model describes seven layers Physical Layer, Data Link Layer, Network layer, Transport layer, Session layer, Presentation layer and Application layer.
packet A unit of data. Each message sent between two network devices is often subdivided into packets by the underlying hardware and software. Depending on the protocol the packets have their own formats. A packet typically consists of three elements: the first element is a header, which contains the information needed to get the packet from the source to the destination (destination address), and the second element is a data area, which contains the information of the user who caused the creation of the packet. The third element of packet is a trailer, which often contains techniques ensuring that errors do not occur during transmission.
   A good analogy is to consider a packet to be like a letter; the header is like the envelope, and the data area is whatever the person puts inside the envelope. The life of one connection will usually comprise a series of packets; in some network designs, they will not necessarily all be routed over the same path through the network.
   In IP networks, packets are often called datagrams. A datagram is a self-contained packet, one which contains enough information in the header to allow the network to forward it to the destination independently of previous or future datagrams.
PCF Short for point coordination function.
PDU Short for protocol data unit.
PHY Short for Physical Layer.
Pilot A single frequency signal (tone) which is transmitted for synchronization or reference purposes.
PLCP Physical Layer Convergence Procedure which maps the frames to the medium.
protocol An agreed-upon format for transmitting data between two devices. The protocol determines the following:
   data compression method, if any
   how the receiving device will indicate that it has received a message
   how the sending device will indicate that it has finished sending a message
   the type of error checking to be used
QR decomposition In linear algebra, the QR decomposition of a matrix is a decomposition of the matrix into an orthogonal and a triangular matrix. The QR decomposition is often used to solve the linear least squares problem. The QR decomposition is also the basis for a particular eigenvalue algorithm, the QR algorithm.
RF Short for radio frequency. RF refers to that portion of the electromagnetic spectrum in which electromagnetic waves can be generated by alternating current fed to an antenna. Various “bands” of interest are:
   Ultra high frequency (UHF) 300-3000 MHz used for television broadcasts mobile phones, wireless LAN, ground-to-air and air-to-air communications
   Super high frequency (SHE) 3-30 GHz used for microwave devices, mobile phones (W-CDMA), WLAN, most modern Radars
RTS Short for request to send. RTS is a signal from the transmission station to the receiving station requesting permission to transmit data. In wireless networks a station sends a RTS frame to another station as the first phase of a two-way handshake necessary before sending the data.
SI units The SI system of units defines seven ST base units: fundamental physical units defined by an operational definition, and other units which are derived from the seven base units, including:
   kilogram (kg), a fundamental unit of mass
   second (s), a fundamental unit of time
   meter, or metre (m), a fundamental unit of length
   ampere (A), a fundamental unit of electrical current
   kelvin (K), a fundamental unit of temperature
   mole (mol), a fundamental unit of quantity of a substance (based on number of atoms, molecules, ions, electrons or particles, depending on the substance)
   candela (cd), a fundamental unit luminous intensity
   degrees Celsius (° C.), a derived unit of temperature. t° C.=tK−273.15
   farad (F), a derived unit of electrical capacitance
   henry (H), a derived unit of inductance
   hertz (Hz), a derived unit of frequency
   ohm (Ω), a derived unit of electrical resistance, impedance, reactance
   radian (rad), a derived unit of angle (there are 2π radians in a circle)
   volt (V), a derived unit of electrical potential (electromotive force)
   watt (W), a derived unit of power
SNR Short for signal-to-noise ratio. Signal-to-noise ratio is an engineering term for the power ratio between a signal (meaningful information) and the background noise. Because many signals have a very wide dynamic range, SNRs are usually expressed in terms of the logarithmic decibel scale.
SOC Short for system on chip.
SSID Short for Service Set Identifier. SSID is a unique name shared among all clients and nodes in a wireless network. The SSID address is identical for each clients and nodes in the wireless network.
STBC Short for space-time block coding. STBC is a technique used in wireless communications to transmit multiple copies of a data stream across a number of antennas and to exploit the various received versions of the data to improve the reliability of data-transfer. The fact that transmitted data must traverse a potentially difficult environment with scattering, reflection, refraction and so on as well as be corrupted by thermal noise in the receiver means that some of the received copies of the data will be ‘better’ than others. This redundancy results in a higher chance of being able to use one or more of the received copies of the data to correctly decode the received signal. In fact, space-time coding combines all the copies of the received signal in an optimal way to extract as much information from each of them as possible
Synchronous A form of communication transmission with a direct timing relationship between input and output signals. The transmitter and receiver are in sync and signals are sent at a fixed rate.
TBF Short for transmitter beam forming. TBF generally involves directing a beam from a transmitter (Tx) to a receiver (Rx) using multiple (2 or more) antennas.
TCP/IP Short for Transmission Control Protocol/Internet Protocol. TCP/IP is the language governing communications between all computers on the Internet. TCP/IP is a set of instructions that dictates how packets of information are sent across multiple networks. It also includes a built-in error-checking capability to ensure that data packets arrive at their final destination in the proper order.
Units of Measurement Various units of length may be used or referred to herein, as follows:
   meter A meter (m) is the SI unit of length, slightly longer than a yard. 1 meter=˜39 inches. 1 kilometer (km)=1000 meters=˜0.6 miles. 1,000,000 microns=1 meter. 1,000 millimeters (mm)=1 meter. 100 centimeters (cm)=1 meter
   micron (μm) one millionth of a meter (0.000001 meter); also referred to as a micrometer.
   mil 1/000 or 0.001 of an inch; 1 mil=25.4 microns
   nanometer (nm) one billionth of a meter (0.000000001 meter).
VoIP Short for Voice over Internet Protocol. VoIP (also called IP Telephony, Internet telephony, and Digital Phone) is the routing of voice conversations over the Internet or any other IP-based network. The voice data flows over a general-purpose packet-switched network, instead of traditional dedicated, circuit-switched voice transmission lines.
WiFi Also Wireless LAN (WLAN) or IEEE 802.11. WiFi is a set of product compatibility standards for wireless local area networks (WLAN) based on the IEEE 802.11 specifications. New standards beyond the 802.11 specifications, such as 802.16(WiMAX), are currently in the works and offer many enhancements, anywhere from longer range to greater transfer speeds. WiFi is meant to be used generically when referring to any type of 802.11 network, whether 802.11b, 802.11a, dual band, etc. The term is promulgated by the Wi-Fi Alliance. Any products tested and approved as “Wi-Fi Certified” (a registered trademark) by the Wi-Fi Alliance are certified as interoperable with each other, even if they are from different manufacturers. A user with a “Wi-Fi Certified” product can use any brand of access point (AP) with any other brand of client hardware that also is certified. Typically, however, any Wi-Fi product using the same radio frequency (for example, 2.4 GHz for 802.11b or 11 g, 5 GHz for 802.11a) will work with any other, even if not “Wi-Fi Certified.” Formerly, the terms “Wi-Fi” was used only in place of the 2.4 GHz 802.11b standard, in the same way that “Ethernet” is used in place of IEEE 802.3.
WIMAX WiMAX is an acronym for Worldwide interoperability for Microwave Access a standards-based wireless technology which provides broadband connections over long distances.
WLAN Short for Wireless Local Area Network. Also referred to as LAWN. A WLAN is a type of local-area network that uses high-frequency radio waves rather than wires for communication between nodes (e.g., between PCs). A WLAN is a flexible data communication system implemented as an extension to or as an alternative for a wired LAN. With WLANs, users can access shared information without looking for a place to plug in. Wireless LAN systems provide WLAN users access to real-time information anywhere in their organization at work, at home and on road. WLANs combine data connectivity with user mobility through simplified configuration.
WLAN Short for “wireless local-area network” (wireless LAN). Also referred to as LAWN. A WLAN is a type of local-area network that uses high-frequency radio waves rather than wires for communication between nodes (e.g., between PCs).

### BRIEF DESCRIPTION (SUMMARY) OF THE INVENTION

The present invention is generally directed to a method for reducing the non-data component of wireless connection bandwidth, whenever possible, while complying with the relevant IEEE 802.11x standard or alterations of the protocol based on this standard.

The present invention is generally a method for reducing the cost of sending Channel State Information (CSI) over a return channel wireless network, and using this information to adaptively control beam forming.

Beam forming is a technique in which a plurality of antennas are employed to form a transmission beam that is adapted to a channel with varying conditions. Beam forming improves the overall quality of data transfer using the wireless channels and can provide higher throughput. On the other hand, the process of determining the coefficients of the channel response function required for beam forming uses the same wireless resources as the actual data transfer. One implementation method for acquiring said coefficients is through sounding and subsequently sending back to the transmitter a beam forming response packet. If the channel is time varying, this operation needs to be done periodically, and so consumes a substantial amount of channel resources. Advantageously, sounding is relatively short, so most of these resources sum up to the response packet.

The invention is particularly advantageous when applied to beam forming, because CSI for beam forming has large volume, significant comparing to other forms of overhead (such as packet headers, MAC layer overhead, channel estimation time). With beam forming, the quality of the overhead data (the accuracy of the channel coefficients) drops when signal-to-noise ratio (SNR) is low, which is just the case where also communications is slow, and thus transmitting these coefficients will take a long time. The invention takes advantage of the fact that with beam forming, there are conditions where the data is irrelevant in part (below measurement accuracy) and expensive to transmit at the same time, so reducing the volume is very reasonable.

The invention generally enables the user of explicit transmitter beam forming in a wireless communication application to coordinate the feedback coefficient resolution, the quality of the communication channel and the spectral efficiency of the response packet. This can ensure an overall lower bound on the cost of the beam forming response coefficient packet.

According to an embodiment of the invention, the process starts with receiving a packet sent over a wireless connection, which is used for the estimation of the CSI, and where the request for return CST estimation may be embedded. The Channel State Information (CSI) is estimated using the packet, wherein the CSI is essentially a plurality of coefficients describing the channel response. Subsequently, a quantizing process or any other lossy compression process of the coefficients or a function of the coefficients is conducted.

This process takes into account at least one of the following parameters: signal to noise ratio (SNR) of said channel, actual data transfer rate, or any other qualitative and/or quantitative parameter of the channel.

The adaptive parameters of the compression process are the product of a decision of the receiver recipient of the packet, the transmitter of the packet, or of a mutual decision.

The quantization or any other lossy compression yields varying size coefficients in accordance with said parameters.

Finally, the coefficients are sent over the return channel so that the transmitter will be able to send future data in a more optimized manner by using the CST.

Beam forming improves the overall quality of the wireless channel, but determining the coefficients uses the same wireless resources. One implementation method is through sounding and responding with a beam forming response packet. If the channel is time varying, this operation needs to be done periodically, and consumes a large amount of channel resources. Sounding is relatively short, and most of these resources are dedicated to the response packet (that has to specify the coefficients per tone). Currently (in 802.11n standardization process) explicit beam forming is suggested with fixed coefficient resolution.

According to an embodiment of the invention, using explicit beam forming with fixed coefficient resolution, the response packet size may be reduced by exploiting the dependence between coefficients in different tones (for example smoothing over tones and then sending parameters for part of the tones only). The method of the present invention should be applied after such coding is done, on the smoothed coefficients. Another embodiment, more optimal but more complicated and less likely to be applied, is to combine the two stages into one.

Although the invention is designed to improve beam forming performance in WLANs, the scope of the invention is not limited in this respect. The invention may serve as a way to reduce transfer load of adaptively determined coefficients in any communication system that utilizes similar coefficients, such as systems that use pre-coding equalization mechanisms and the like.

Other objects, features and advantages of the invention will become apparent in light of the following description thereof.

### BRIEF DESCRIPTION OF DRAWINGS

Reference will be made in detail to embodiments of the invention, examples of which may be illustrated in the accompanying drawing figures. The figures are intended to be illustrative, not limiting. Although the invention is generally described in the context of these embodiments, it should be understood that it is not intended to limit the spirit and scope of the invention to these particular embodiments.

FIG. 1A is a diagram of a conventional SISO wireless system of the prior art.

FIG. 1B is a diagram of a conventional MIMO wireless system of the prior art.

FIG. 1C is a diagram illustrating receive beamforming, according to the prior art.

FIG. 1D is a diagram illustrating transmit beamforming, according to the prior art.

FIG. 1E is a diagram illustrating the spatial multiplexing MIMO concept, according to the prior art.

FIG. 1F is a diagram illustrating the spatial multiplexing MIMO reality, according to the prior art.

FIG. 1G is a diagram illustrating the MIMO hardware requirements for a MIMO transmitter (employing parallelism and data rate scaling), according to the prior art.

FIG. 1H is a diagram illustrating the MIMO hardware requirements for a MIMO receiver (employing parallelism and data rate scaling), according to the prior art.

FIG. 1I is a diagram illustrating a WLAN station, according to the prior art.

FIG. 2 is a block diagram showing a wireless local area network (WLAN) having stations in which the present invention may be incorporated;

FIG. 3 is a flowchart showing the operation of an embodiment of the present invention;

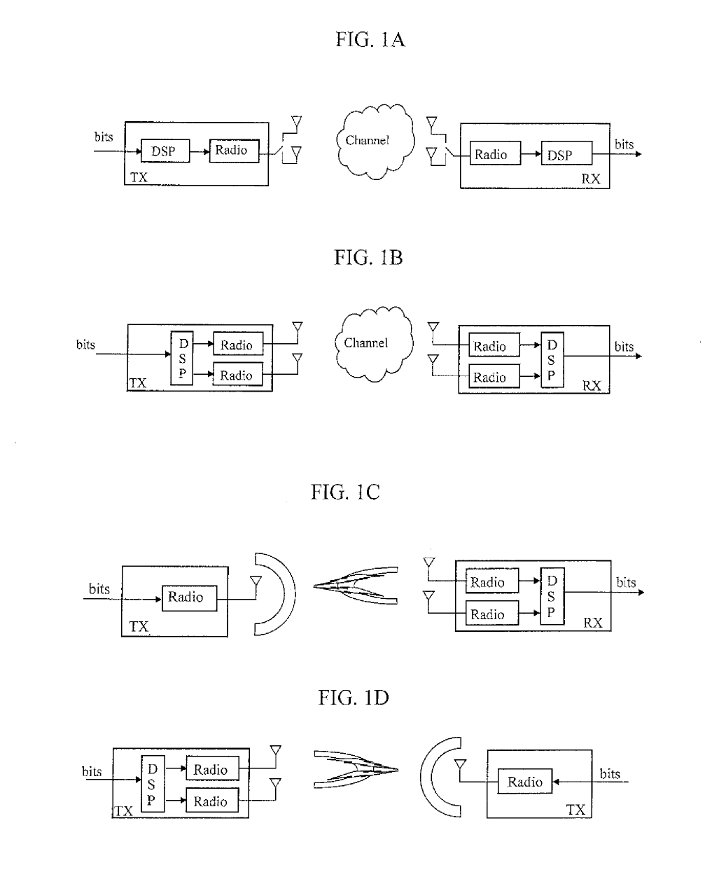

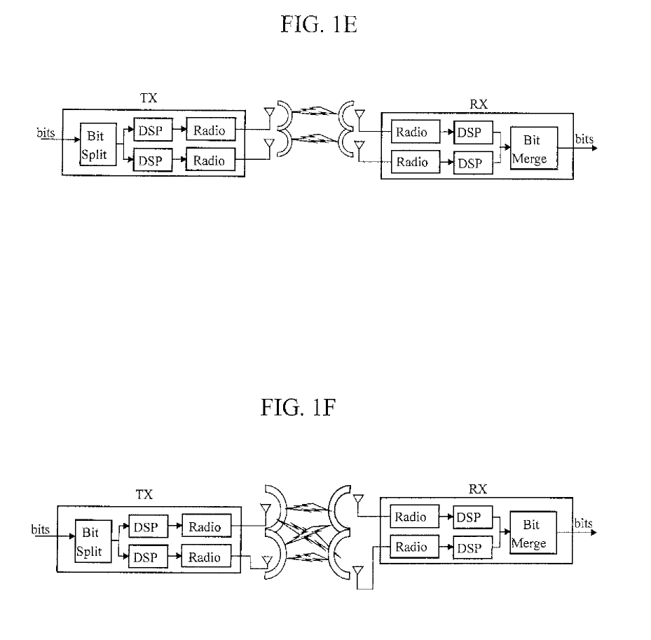

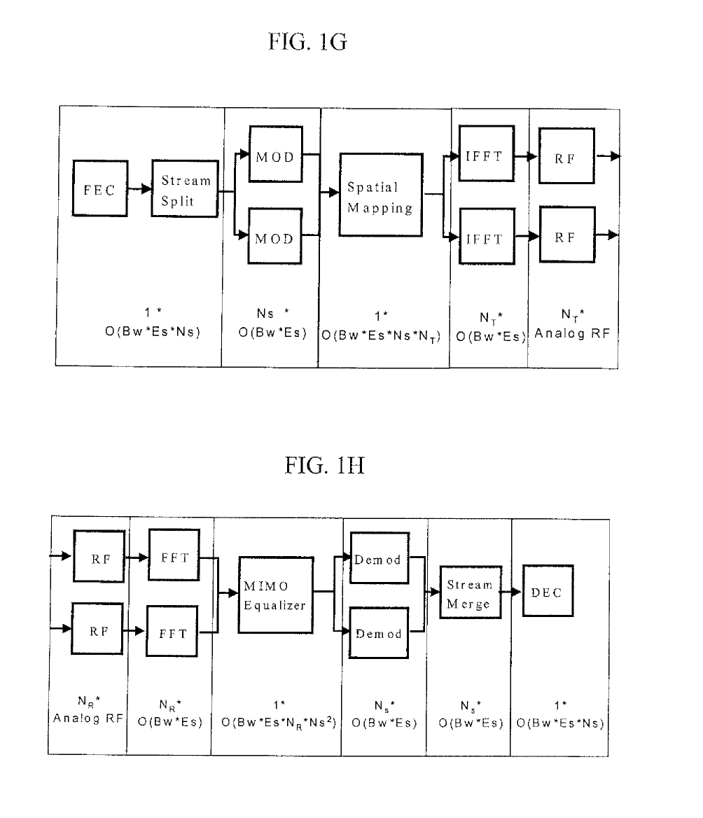

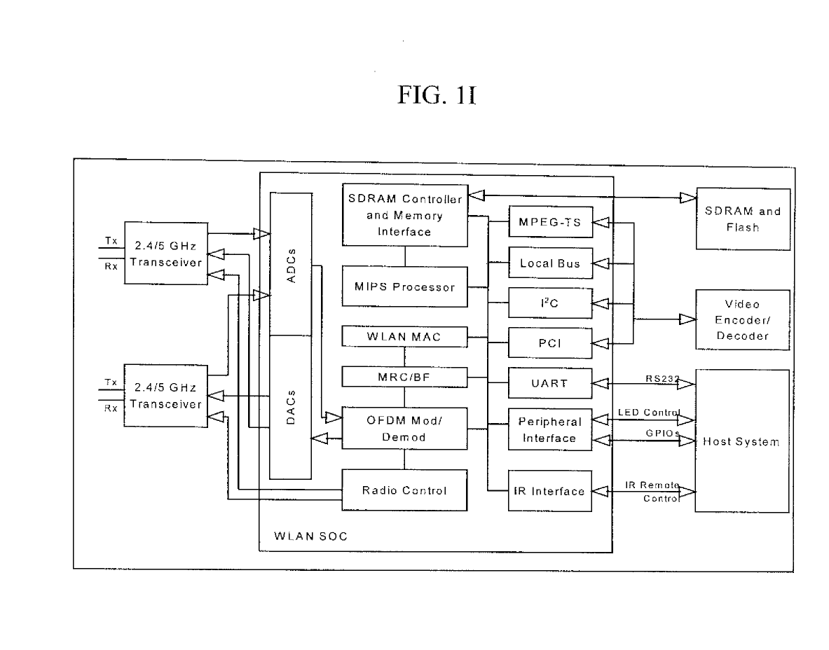

### DETAILED DESCRIPTION OF THE INVENTION

In the following description, numerous specific details are set forth to provide a more thorough understanding of the invention. However, it will be apparent to one of skill in the art that the invention may be practiced without one or more of these specific details. In other instances, well-known features have not been described in order to avoid obscuring the invention.

There is disclosed herein a method for sending channel related parameters known as channel state information (CSI) over a WLAN return channel. These parameters describe the channel response function and arc sent via a return/feedback channel to the transmitter as a means for optimizing the transmission process.

The size of these coefficients is not fixed. Rather, the coefficients arc quantized in a certain manner that may yield each time a different size of coefficient in terms of total data volume. Said quantization or any other form of lossy compression is based upon parameters such as signal to noise ratio (SNR) of the channel and/or actual data transfer rate and/or quality of the forward communication link and/or quality of the return communication link and/or other qualitative and/or quantitative parameters of the channel. Quantization or any other lossy compression method may also be performed directly on the CST estimation, or on a function of said estimation. By choosing a different resolution for these coefficients for every return channel feedback, the part of the bandwidth of the wireless connection that is not payload transfer (such as the coefficient feedback) is minimized. (It should be understood that any other form of lossy compression process may replace the process of quantization.)

According to an embodiment of the invention, a default resolution for the coefficients is a pre-defined high resolution for said coefficients. The number of sent bits is lowered when there is little or no loss in sending the coefficients with lower resolution, or when the cost of the wireless channel resource for high-resolution transfer through the return channel is too large. This is the case, for example, in low levels of SNR, which typically coincides with low data transfer rates in WLAN transfer. In the case of low SNR in the forward channel, the estimation of the CSI is of relatively low quality, so that it can be described well by correspondingly low-resolution coefficients. Alternatively, low SNR in the return channel would typically coincide with low return transfer rate, and would thus yield high resource cost in sending the return CSI estimation. In many cases the forward and return channels are of similar quality, so that the cases where high-resolution coefficients are not needed, and sending these high-resolution coefficients consumes too large resources, coincide. Completing the picture, the low SNR in the forward channel would render the requirement for high CST coefficient resolution superfluous.

In one embodiment of the invention, the receiver of the sounding packet which is used to estimate the CSI would also be used to estimate the channel SNR, and the estimation of the channel SNR is used to set the quantization resolution or other compression parameters.

An appropriate choice of quantization resolution can be made, as follows. The estimation MSE (Minimum Square Error) of the channel coefficients grows linearly with the channel noise variance. Thus for every 6 dB fall in channel SNR, one bit of the estimated coefficients drops below the measurement resolution. As for the CSI packet, for every 6 dB fall in channel SNR, the transfer rate falls by 1 bit/sec/Hz. By setting the quantization noise to be always within some margin (say 6 dB) below the estimation noise, the quantization noise effect will be always negligible, while the duration of the CSI packet will remain fixed.

In another embodiment of the invention, the receiver would use the transfer rates in the forward link, or the transfer rate in the return link.

In another embodiment of the invention, the transmitter of the sounding packet would determine the coefficient resolution according to its own assessment of the channel quality.

In another embodiment of the invention, the indication of quantization resolution or any other compression parameters may be embedded in the packet containing the return CSI, in the packet requesting the return CSI (preferably the sounding packet), or predefined.

The present invention increases the feasibility of beam forming implementation using return CSI in terms of both resource cost and performance in low quality channels. This is because for such channels, the utilization of a fixed, high-resolution quantization, which is determined in advance according to the maximal resolution requirement, is too costly. Alternatively, in high quality channels, the CSI may still be transferred with the required high resolution, because the resolution is adaptively defined.

The receiver of the sounding packet (and the initiator of the response packet) has the freedom to set the resolution of the response coefficients. This enables coordination of the feedback coefficient resolution, the quality of the communication channel and the spectral efficiency of the response packet.

Setting the coefficient resolution according to the received SNR is logical because:
The quality of estimation is SNR dependent.
The quality of the channel towards the initiator of the beam forming request (the Tx channel) is similar to the quality of the Rx channel.

The techniques disclosed herein provide an upper bound on the cost of the beam forming response packet over all SNRs with sustained beam forming quality

The invention is generally directed towards the 802.11n standard. However, the techniques disclosed herein are applicable for any multiple-antenna communication system. More generally, in situations where any coefficients are fed back (precoder, for example), the general idea is that when the channel is bad and communication is slow, coefficients resolution can be made lower without loss of performance.

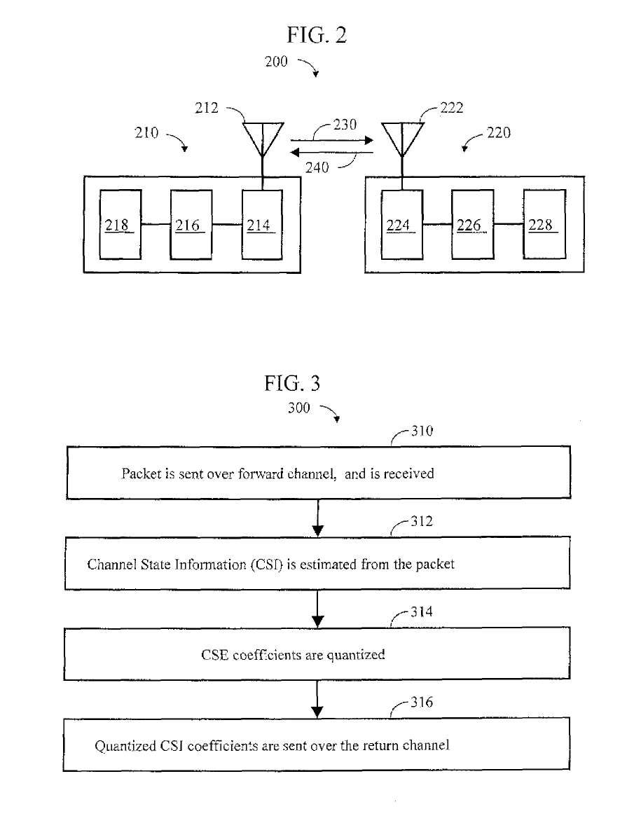

FIG. 2 is a block diagram of an exemplary IEEE 802.11x—compliant WLAN connection 200 between two WLAN stations 210, 220. By way of example, one of the two WLAN stations (210) is an access point (AP) connected to a network (not shown) such as the Internet, and the other station (220) is a client station (CS). The diagram illustrates a forward channel 230 and a return channel 240 between the two stations. It is within the scope of the invention that the two WLAN stations 210 and 220 both client stations.

Each WLAN station 210, 220 comprises at least one antenna 212, 222, respectively. In the case of CSI used for beam forming, there are a plurality of antennas associated with each of the stations. In the station 210, the antenna 212 is connected to transceiver 214, the transceiver 214 is connected to a processing unit 216 for Media Access Control (MAC), and the processing unit 216 is connected to a memory module 218. Similarly, in the station 220, the antenna 222 is connected to transceiver 224, the transceiver 224 is connected to a processing unit 226 for Media Access Control (MAC), and the processing unit 226 is connected to a memory module 228.

According to certain IEEE 802.11x standards, a connection between two stations comprises a forward channel for transmitting data from one station to another, and a return channel for the receiving station to transmit back information regarding the channel state. In this manner, the next transmission can be adjusted based on conditions of the connection. This concept applies to both stations in a connection, since over the course of a communications session, either one of the stations may be the transmitting station at a given time.

FIG. 3 is a flowchart 300 showing the overall operation of an embodiment of the invention.

In a first step 310, a subject packet is sent over the forward channel, and is received. Next, in a step 312, Channel State Information (CSI) is extracted from the received packet. Next, in a step 314, CSI coefficients, or a set of coefficients which are a function of said CSI coefficients, are quantized, wherein quantization resolution, which determines coefficients size, is set according to parameters of the received signal (packet) such as signal to noise ratio (SNR) and actual data transfer rate as discussed above and/or any qualitative and quantitative parameters of the channel. Finally, in a step 316, the quantized, varying sized coefficients are sent back over the return channel to station which transmitted the subject packet.

According to an aspect of the invention, the result of the above-mentioned method is CSI coefficients having lengths which are related to the qualitative and quantitative parameters of the channel.

According to another aspect of the invention, the coefficients resolution is reduced in cases of low SNR.

According to another aspect of the invention, when data transfer rate is low, the coefficients resolution is reduced.

According to another aspect of the invention, sending the CSI over the return channel may be performed ‘indirectly’, meaning that some form of processing, such as Givens/Householder rotations, is applied on CSI prior to sending its coefficients over the return channel, thus forming a ‘processed CSI feedback’. The present invention is capable of dealing with processed CSI feedback as well, by applying the variable-resolution quantization to the decomposed coefficients. In other words, prior to the quantization, the data may pass some other processing. The invention is not limited to whether such processing is applied or not, and which processing it is. The point is, that there is a set of numbers that need to be quantized and sent back to the transmitter.

Specifically, said decomposed quantization may include scalar quantization when feeding back Givens rotations, or vector quantization (VQ) when feeding back Householder rotations. When VQ is used, the effective number of bits per coefficient is reduced by reducing the number of code words in the VQ code book. For example, if N is the number of code words and M is the VQ dimension (i.e. the number of coefficients coded together), then the number of bits used per coefficient would be: I/N log2 (M).

For example, reducing the code words number by a factor of 2 when 3 coefficients are coded together saves ⅓ bit per coefficient.

It should be understood that embodiments of the present invention may be used in a variety of applications. Although the present invention is not limited in this respect, the techniques disclosed herein may be used in many apparatuses such as in the transmitters and receivers of a radio system. Radio systems intended to be included within the scope of the present invention include, by way of example only, wireless local area networks (WLAN) devices and wireless wide area network (WWAN) devices including wireless network interface devices and network interface cards (NICs), base stations, access points (APs), gateways, bridges, hubs, cellular radiotelephone communication systems, satellite communication systems, two-way radio communication systems, one-way pagers, two-way pagers, personal communication systems (PCS), personal computers (PCs), personal digital assistants (PDAs), and the like.

Types of wireless communication systems intended to be within the scope of the present invention include, although not limited to, Wireless Local Area Network (WLAN), Wireless Wide Area Network (WWAN), Code Division Multiple Access (CDMA) cellular radiotelephone communication systems, Global System for Mobile Communications (GSM) cellular radiotelephone systems, North American Digital Cellular (NADC) cellular radiotelephone systems, Time Division Multiple Access (TDMA) systems, Extended-TDMA (E-TDMA) cellular radiotelephone systems, third generation (3G) systems like Wide-band CDMA (WCDMA), CDMA-2000, and the like

The invention has been illustrated and described in a manner that should be considered as exemplary rather than restrictive in character—it being understood that exemplary embodiments have been shown and described, and that all changes and modifications that come within the spirit of the invention are desired to be protected. Undoubtedly, many other “variations” on the techniques set forth hereinabove will occur to one having ordinary skill in the art to which the present invention most nearly pertains, and such variations are intended to be within the scope of the invention, as disclosed herein.

What is claimed is:

1. A method of sending channel related data over a communication link, said method comprising the steps of:
(a) receiving a packet sent from a transmitter over a forward channel;
(b) estimating channel state information (CST) from said packet;
(c) applying a lossy compression method over said CST, resulting in varying size coefficients, wherein the resolution of said coefficients is dependent upon qualitative and/or quantitative channel-related parameters; and
(d) sending said varying size coefficients over a return channel to the transmitter.

2. The method of claim 1, wherein:
the communication link is a wireless communications link.

3. The method of claim 1, wherein:
a sounding packet is sent from the transmitter to the receiver on the forward channel;
the receiver of the sounding packet estimates the CSI and also estimates the channel SNR; and
the estimation of the channel SNR is used to set the quantization resolution. parameters.

4. The method of claim 1, wherein:
the communication link comprises radio systems selected from the group consisting of wireless local area networks (WLAN) devices, wireless wide area network (WWAN) devices, wireless network interface devices, network interface cards (NICs), base stations, access points (APs), gateways, bridges, hubs, cellular radiotelephone communication systems, satellite communication systems, two-way radio communication systems, one-way pagers, two-way pagers, personal communication systems (PCS), personal computers (PCs), personal digital assistants (PDAs), and the like.

5. A method for sending channel related data over a communication link, said method comprising the steps of:
(a) at a receiver, receiving a packet sent by a transmitter over a forward channel;
(b) estimating channel state information (CSI) from said packet;
(c) quantizing said CSI into varying size coefficients, wherein the resolution of said coefficients is dependent upon at least one of the following parameters:
signal to noise ratio (SNR) of forward channel;
signal to noise ratio (SNR) of return channel;
actual data transfer rate in the forward channel; and
actual data transfer rate in the return channel;
(d) sending said varying size coefficients over the return channel to the transmitter.

6. The method of claim 5, wherein:
in the step (c), a function of the channel coefficients is quantized.

7. The method of claim 5, wherein:
said quantizing comprises vector quantization (VQ).

8. The method of claim 5, wherein:
the communication link is a wireless communications link.

9. The method of claim 5, wherein:
a sounding packet is sent from the transmitter to the receiver on the forward channel;
the receiver of the sounding packet estimates the CSI and also estimates the channel SNR; and
the estimation of the channel SNR is used to set the quantization resolution.

10. The method of claim 5, wherein:
the communication link comprises radio systems selected from the group consisting of wireless local area networks (WLAN) devices, wireless wide area network (WWAN) devices, wireless network interface devices, network interface cards (NICs), base stations, access points (APs), gateways, bridges, hubs, cellular radiotelephone communication systems, satellite communication systems, two-way radio communication systems, one-way pagers, two-way pagers, personal communication systems (PCS), personal computers (PCs), personal digital assistants (PDAs), and the like.

11. A method of wireless communication, comprising:
(a) sending a packet over a forward channel;
(b) receiving the packet;
(c) estimating channel state information (CSI) from the received packet;
(d) determining coefficients for the CSI, wherein the coefficients are dependent upon adaptive qualitative and/or quantitative channel-related parameters; and
(e) sending said coefficients over a return channel.

12. The method of claim 11, wherein:
the coefficients are determined by applying a lossy compression method to the CSI.

13. The method of claim 12, wherein:
the coefficients are determined by quantizing said CSI into varying size coefficients, wherein the resolution of said coefficients is dependent upon at least one of the following parameters:
signal to noise ratio (SNR) of forward channel;
signal to noise ratio (SNR) of return channel;
actual data transfer rate in the forward channel; and
actual data transfer rate in the return channel.

14. The method of claim 11, further comprising:
enabling a user of explicit transmitter beam forming to coordinate feedback coefficient resolution, the quality of the communication channel and the spectral efficiency of a response packet.

15. The method of claim 11, wherein:
the packet which is sent comprises a request for return CSI estimation.

16. The method of claim 15, wherein:
CSI is estimated using the packet.

16. The method of claim 11, wherein the step (d) of determining coefficients comprises:
taking into account at least one of the following parameters: signal to noise ratio (SNR) of said channel, actual data transfer rate, or any other qualitative and/or quantitative parameter of the forward channel.

17. The method of claim 11, wherein:
the adaptive parameters are the product of a decision of the receiver recipient of the said packet, the transmitter of the packet, or of a mutual decision.

18. The method of claim 11, wherein:
the quantization or any other lossy compression yields varying size coefficients in accordance with said adaptive parameters.

19. The method of claim 11, further comprising:
(e) receiving the coefficients at the transmitter so that the transmitter will be able to send future data in a more optimized manner by using the varying size coefficients of CSI.

20. The method of claim 19, wherein:
the varying-size coefficients are used by the transmitter for beam forming.

21. A method of optimizing a transmission process over a WLAN channel comprising a forward communication link and a return communication link, the method comprising:
from a receiver, sending channel related parameters over a WLAN return channel to a transmitter, wherein the parameters describe a channel response function and are sent via a return/feedback channel to the transmitter as a means for optimizing the transmission process.

22. The method of claim 21, wherein:
the parameters are varying-size coefficients of channel state information (CSI) and are generated in a manner that may yield each time a different size of coefficient in terms of total data volume.

23. The method of claim 22, wherein:
the coefficients are generated by quantization or any other form of lossy compression and are based upon parameters such as signal to noise ratio (SNR) of the channel and/or actual data transfer rate and/or quality of the forward communication link and/or quality of the return communication link and/or other qualitative and/or quantitative parameters of the channel.

24. The method of claim 23, wherein:
a sounding packet is sent from the transmitter to the receiver on the forward channel;
the receiver of the sounding packet estimates the CSI and also estimates the channel SNR; and
the estimation of the channel SNR is used to set the quantization resolution or other compression parameters.

25. The method of claim 21, wherein:
an indication of quantization resolution or any other compression parameters are embedded in the packet containing the return CSI, in the packet requesting the return CSI (preferably the sounding packet), or are predefined.

26. The method of claim 21, wherein:
a resolution of quantization for CSI is adaptively defined.

27. The method of claim 21, wherein:
the coefficient resolution is set according to the received SNR.

28. The method of claim 21, wherein:
the quantization resolution is set by dropping one bit of the estimated coefficients for every 6 dB fall in channel SNR.

29. The method of claim 22, wherein:
the coefficients are generated by choosing a different resolution for the coefficients for every return channel feedback.

30. The method of claim 29, wherein:
the number of sent bits is lowered when there is little or no loss in sending the coefficients with lower resolution, or when the cost of the wireless channel resource for high-resolution transfer through the return channel is too large.

31. The method of claim 30, wherein:
the number of sent bits is lowered when there are low levels of SNR.

32. The method of claim 21, further comprising:
setting a default resolution for the coefficients which is a pre-defined high resolution for said coefficients.

33. The method of claim 21, wherein:
a sounding packet is sent from the transmitter to the receiver on the forward channel; and
the transmitter of the sounding packet determines the coefficient resolution according to its own assessment of the channel quality.

34. The method of claim 21, wherein:
a sounding packet is sent from the transmitter to the receiver on the forward channel; and
the receiver of the sounding packet (and the initiator of the response packet) has the freedom to set the resolution of the response coefficients.
